(19) United States
(12) Patent Application Publication
(10) Pub. No.: US 2003/0208719 A1
(43) Pub. Date: Nov. 6, 2003

(54) Immigration law case management system

(75) Inventor: John Charles Fay JR., New York, NY (US)

Correspondence Address: NOTARO AND MICHALOS, 100 DUTCH HILL ROAD, SUITE 110, ORANGEBURG, NY, 10962-2100, US

(73) Assignee: Ronald W. Freeman, P.C.

(21) Appl. No.: 10/139,516

(22) Filed: May 6, 2002

(51) Int. Cl. G06F 17/00

(52) U.S. Cl. 715/507

(57) ABSTRACT

A system and method are provided for creating, processing, and completing a case online with automated notifications and automated population of forms or other relevant documents. The system and method include Internet-based software, shared and relational database driven form generation, online security measures, real-time tracking of cases, backup alternatives, and automated e-mail capabilities.

### FIELD AND BACKGROUND OF THE INVENTION

The present invention relates generally to the field of case management software and in particular to a new and useful immigration law software for obtaining client data and electronically performing legal tasks based on the client data while electronically consulting attorneys, paralegals, other parties involved in a case, and the client.

Legal immigration averaged 507,000 people per year from 1966 to 1989, and increased to 800,000 people per year during the 1990's. At the beginning of fiscal year 2000, there were 849,807 legal immigrants applying for resident status, and at the end of fiscal year 2000, there were 1 million adjustment of status cases pending a decision.

Clearly, immigration in the United States is continually growing. Immigrants face many different legal issues including those involving status rights, work permission, asylum, and deportation. Often, an immigrant will be required to prepare a form provided by the INS, the Department of Labor, or Department of State in relation to one of these legal issues. Over 100 forms are currently identified at the websites of all three of these government agencies.

Several commercially available programs have been developed to help attorneys manage immigration law caseloads. For example, the company Immigrant Software offers two programs: Immigrant Forms Gold, and Immigrant Professional. Immigrant Forms Gold (IFG) is an INS forms processor with step-by-step wizard integration, support for different database formats including SQL server database, barcode recognition and direct filing of forms with INS. IFG can also automatically track important dates with reminders, and generate reports.

Immigrant Professional is an advanced forms processor that also provides case tracking and management, docketing and reports. Immigrant Pro uses an industry-standard database format known as dBase. File templates are provided for a particular client or type of client. A client status sheet may be generated which contains biographical data and immigration status for a particular client. Due dates and requested documents can also be provided in the client status sheet. Case tracking allows a practitioner to create a schedule for a case, including important dates. The software also provides document tracking of requested documents, a to-do list generator, and calendar reminders.

However, neither of the Immigrant Software products provides an Internet or web-enabled interface for obtaining information from a client. Instead, a user must interview the client and manually enter the case data into the software. Furthermore IFG has no case management or file tracking capabilities. Although Immigrant Pro has case management and document tracking capabilities, it does not permit data sharing between a dBase-formatted database and the Immigrant Pro data management systems. The information stored in dBase format must be re-entered into the Immigrant Pro software to provide client status sheets and complete INS forms.

Another case management software package for immigration lawyers is Immigration Assistant for Windows. Immigration Assistant provides approximately 185 INS forms, a text search and retrieval service, including relevant statutes and codes, and other reference tools. Scanning software allows electronic customization of forms. The Immigration Assistant software only provides reference tools and form customization. No case management functions or client information database are provided. All data is entered manually into the customized electronic forms that are scanned.

Case management software is available for non-specialized general legal practice. For example, ProLaw is a program that provides generic case management, relationship management, and document management. Custom fields can be created for the specific types of data, such as names, places, and dates. Forms are provided that may be populated with information such as the client's name and the opposing party's name. Authorized users may access case information stored using ProLaw via the Internet. Clients can also be permitted to check the status of their case using a Web browser.

ProLaw includes integration with the Microsoft OUTLOOK e-mail program so that clients in the Outlook address book may be easily contacted, but notices are not automatically generated and sent using the e-mail program. Records management tracks all physical files associated with a case. Bar codes may be used to check files in and out of cases.

However, ProLaw does not have web-based questionnaires for obtaining information from a client. Event notification via E-mail is also not automated. Most of the forms are populated with general information such as the names of the parties, but the attorney must provide the arguments of a specific case.

In addition, U.S. Pat. No. 5,956,687 discloses a legal claim management system, comprised of a computer with software. The software operates in several different phases of a personal injury claim process. In each phase, the software is programmed to create prompts for collecting information regarding the claim. The same software also generates documents which incorporate the information that has been received in a particular phase. In one phase following medical treatment of the injured party for example, medical provider records and bills, and information concerning economic loss, such as lost wages, are gathered and added to a record database by an input device. Once the appropriate information is gathered, it is organized in a persuasive letter, which proposes an amount of compensation needed to settle the client's claim.

Although U.S. Pat. No. 5,956,687 discloses a system for collecting, organizing, and managing data for a particular case, it does not use a WAN for accessing the information on the computer globally, a mail server for messaging clients or notifying attorneys or other workers that are assigned to the case.

U.S. Pat. No. 6,330,551 teaches a computerized dispute resolution system, which is operated through an Intranet website via the Internet. The system comprises a computer with a processor controlled by operating system software and a memory device for storing information corresponding to the identification of the dispute and the and the persons involved in the dispute. The system is designed to allow a user to communicate with the system through a computer and modem via the Internet. The processor and software collect information via interaction with the parties over the Internet and process a series of demands based on the collected information. Demands are compared to offers made by the opposing party, and a settlement is reached where there is an overlap.

An Internet-based version of the software disclosed in U.S. Pat. No. 6,330,551 includes a database application written in ColdFusion and HTML programming languages. The system is distributed through ColdFusion server extensions and an SQL server. The system incorporates other software for securing against unauthorized traffic such as a firewall, the use of encryption technology, and password protection for privacy or other user authentication. A voice messaging system is also included for generating voice messages to a person communicating with the system via a phone.

While U.S. Pat. No. 6,330,551 teaches a system with a relational database such as SQL, and ColdFusion controlled collection and processing of the information, access to the information via the Internet, and software-controlled security measures, it does not provide a mail server for electronically messaging the parties involved in the dispute, electronic signing software and a backup server, among other features. In addition, the voice messaging system is used for technical assistance rather than event notification.

None of the general law case management systems is particularly adapted to the practice of immigration law, which has its own special requirements. New case management software is needed which provides the functions and services required by immigration law attorneys and their clients and employees for reducing and eliminating errors and delays caused by transcription of data, missed dates and slow communication.

Many immigrants to the United States are well-educated people who are comfortable using computers and the Internet. These same people may not have a large amount of time to meet with an immigration attorney due to their work or other obligations. Case management software which permits an existing immigration client or a new client to contact their preferred attorney at any time and initiate assistance with an immigration law issue is needed to save these people time. Similarly, such software is needed to reduce the amount of non-productive time an immigration law attorney spends on new cases obtaining information and getting basic facts from a client.

### SUMMARY OF THE INVENTION

It is an object of the present invention to provide a system and method for efficiently managing immigration law cases by automating the preparation of all immigration-related forms, documents, and other materials, sharing and linking data online from various sources, and ensuring quality control through file tracking and secure archiving.

It is a further object of the present invention to provide case management software having a shared relational database for storing client information and making the client information available to other programs and routines, including form generating or report generating programs and routines.

Yet another object of the present invention is to provide an Internet-based system and method of case management, where the case may start with an online intake by a client's input into web form fields from a remote computer, and, subsequently, attorneys, paralegals, and the client can access their case information via the Internet from any location.

Accordingly, a case management method is implemented by a software and hardware system. Internet-based case management software is provided with WAN support for global online interaction, security measures for securing web-based interactions, a mail client server for providing automated e-mail notification to the client, attorneys, and paralegals, a shared relational database, a backup server, customizable client questionnaires and an automated case creation wizard for case creation, and bar code recognition for tracking of cases.

The system permits remote entry and initialization of a new client case by an existing or prospective client, with automatic attorney assignment and notice of the case provided via e-mail, while client and case data are stored in a database for future use.

The initialization of a case is streamlined by allowing the client to complete an intake questionnaire using an Internet web browser without requiring a formal interview. Information from the questionnaire is assimilated and stored in a database for later retrieval and use in any one of several forms that will likely be required. Entry of the client's information is facilitated with the use of pop-up help screens for various questions. A case number coded using a bar code is assigned to the case, so that any physical paper components can be electronically tracked using the assigned bar code printed on the paper components.

The system has automated client and attorney notification via e-mail. E-mails are generated and sent based on the last actions taken in the case entered into the system. Status reports can be sent to the client regularly in one version of the system.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1A is a graphic representation of a case management system according to the present invention;

FIG. 1B is a graphic representation of an alternative embodiment of the system of FIG. 1A including a separate mail server;

FIG. 2 is a graphic representation of a server used in the systems of FIGS. 1A & 1B;

FIG. 3 is a graphic representation of a computer client used with the system of FIGS. 1A & 1B;

FIG. 4 is a flow chart of the method according to the present invention used on a system of FIGS. 1A or 1B; and

FIG. 5 is a detailed flow chart of the steps for creating a case under the method of FIG. 4.

### DESCRIPTION OF THE PREFERRED EMBODIMENTS

A case management method is implemented using a system comprised of both hardware and software. The system provides the benefit of increased efficiency in managing immigration law cases, including streamlining case flow and reduction or elimination of errors and delays in processing client information.

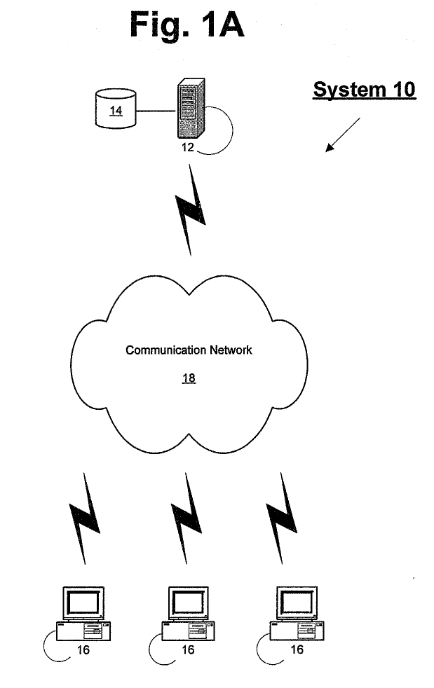

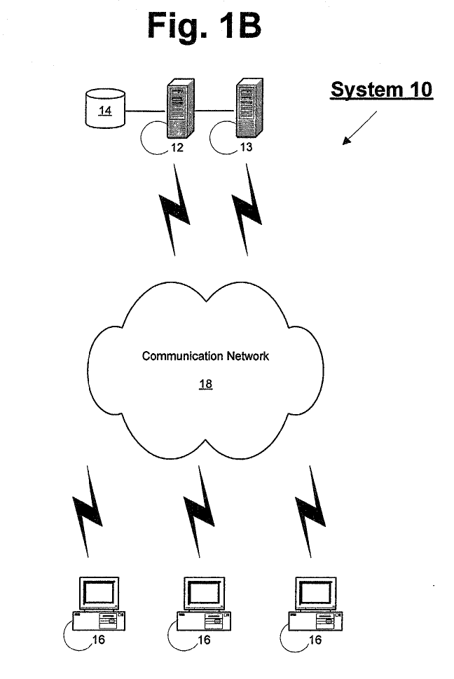

Referring now to the drawings, in which like reference numerals are used to refer to the same or similar elements, FIG. 1A shows a preferred embodiment of an immigration law case management system 10. System 10 has a server 12 that contains a shared relational database 14 and case management server software. A remote user or client computer 16 may connect to the server 12 via a communication network 18. The communication network 18 can include direct, hard wired connections, or be a distributed network, like the Internet.

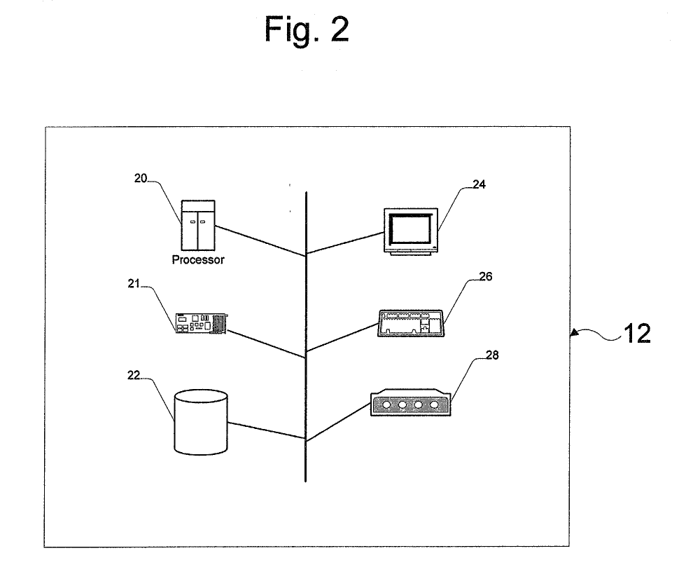

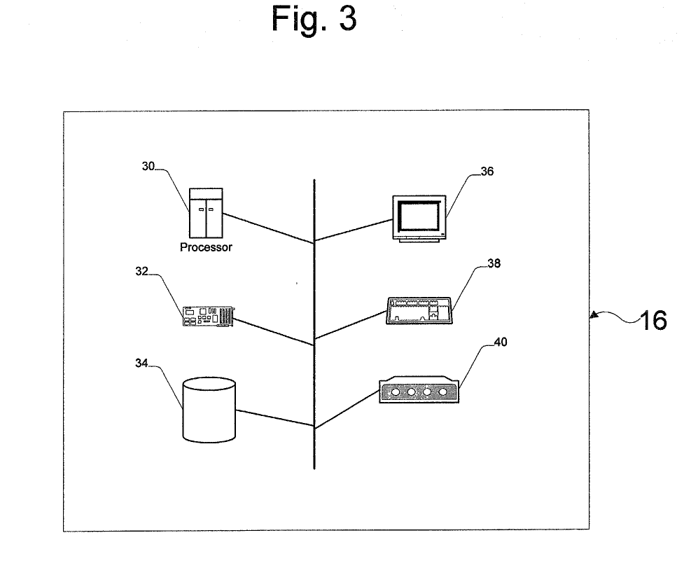

A preferred embodiment of the hardware making up the server 12 is illustrated in FIG. 2. The server 12 is a computer, such as a PC or MAC or dedicated server computer, capable of processing and storing data to be transmitted to the client computer 16. The server 12 can receive and interpret multiple requests for information and/or files from a plurality of client computers 16. The server 12 includes a processor 20, a first storage device, or RAM 21, a second storage device, or hard drive 22, an output 24, an input 26, and a communication device 28.

The second storage device 22 which stores the data, incorporates one or more databases, including shared relational database 14. The shared relational database 14 contains information organized by its relation to other information, as opposed to a rigid data format of fields and records. Information is marked electronically within the database. The information can be accessed and used based on the location of the mark within the database. A relational database consists of a set of tables, where each table is a set of records. A record in turn is a set of fields and each field is a pair field-name/field-value. All records in a particular table have the same number of fields with the same field-names.

A relational database is particularly suitable for integrating information into a form that requires information related to a specific case. Information may be organized specifically for implementation into particular forms and may therefore be found quicker. The relational database 14 is also shared so that information can be stored and used simultaneously by one or more other applications.

The relational database is also enabled for use over the Internet or another distributed computer network. Many types of computer languages can capture the data in the relational database. However, an Internet-compatible language such as Extensible Markup Language (“XML”) is preferred.

A markup language is a set of data descriptions (tags) and rules that simplify and enhance the process of data interchange between different types of computer systems. XML, similar to Hypertext Markup language (“HTML”), uses tags to encode information on the World Wide Web. HTML tells a web browser how to display information while XML defines values for that information. XML can be used to represent a database over the web. In so doing, a client computer 16 may have access to the database for querying.

Microsoft's SQL database is a preferred shared relational database, but other shared relational databases may be used. Microsoft's SQL database is different from Microsoft's Access database which stores information by assigned categories, and has very little integration with other applications. The Access database can store information that can be provided for a mail merge in a word processing program, but the information cannot be used to populate forms in other software such as Immigrant Pro, for example. The SQL database version 2000 is a fully web-enabled database product for XML and has the ability to query across the Internet and beyond a firewall. HTTP can also be used to send queries to the database and perform full text searches on documents stored in the database.

The second storage device 22 of server 12 also stores one or more software applications, including an operating system for operating the server 12 and an e-mail client such as Microsoft Outlook. The output 24 is preferably a monitor for displaying information, but it can include speakers for audio output, among other things. The input 26 is preferably a keyboard and/or a mouse, but can consist of other input devices such as touch pads and tablets, among other input devices. The communication device 28 is preferably either a modem or a network interface card (“NIC”), and most preferably, a NIC, although other communication protocols can be used to transmit information.

The server 12 preferably functions as a mail server as well, that is capable of storing e-mail of attorneys, paralegals, or other personnel in mailboxes on the second storage device 22 or an additional internal or external storage device, such as another hard drive or a removable storage drive, and sending e-mail notifications to a client or to one of the personnel. However, in an alternative embodiment, as shown in FIG. 1A, server 12 has an e-mail client, which is programmed to send e-mail notifications to a mail server 13 via the communication network 18. Alternatively, the mail server 13 is connected to the server 12 via a local area network (LAN) connection. The mail server 13 forwards the e-mail notifications to a specified party.

An in-house backup server may also be provided in the case that the operation of the server 12 is interrupted or there is a network outage. There are various means for transferring and backing up data between two or more devices which are known in the art. The backup server is one of many methods for continued operation of the software that is the subject of this invention.

The backup server may include hardware similar to the server 12. In one embodiment, the mail server 13 can include the backup server as part of its function.

The backup server may operate across an intranet, or private communications network so that at least attorneys and paralegals may continue work on a particular file or case during network outages which are increasingly likely to occur as the use of the Internet exponentially increases. Information stored on the database 14 may be continuously backed up to a storage device on the backup server, and the data may be synchronized between the servers.

The client computer 16, which connects to the server 12 for accessing information on server 12 and its relational database 14, is similarly a computing device with a processor 30, a plurality of storage devices 32 and 34, an output 36, an input 38, and communication hardware 40. However, processor 20 of the server 12 is preferably more powerful than the processor 30 of the client computer 16 because it has multiple requests from a variety of clients and must be capable of multi-tasking. The client computer 16 uses similar input, output, and communication means to the server 12.

Alternatively, the client computer 16 may be a handheld computing device or similar device with an embedded processor such as a Reduced Instruction Set Computer (“RISC”) chip based on MIPS (million instructions per second), ARM (Advanced RISC Machines) or SuperH (e.g., SH-1, SH-4) architecture with 32 bit or 64 bit capability. In this alternative embodiment of client computer 16, a storage device for storing data may be in the form of a permanent internal structure or a removable PCMCIA Flash Card. The input, output, and communications are substantially the same as those of the preferred embodiment of client computer 16, and can include a pen or stylus for input, infrared output, and removable network or modem cards.

The client computer 16 may also have a bar code reader as an input device. A client computer 16, with a bar code reader can scan documents that have been assigned a bar code. An entire case may be assigned a master bar code. The bar code reader can direct a user to the exact location of a case online that he is looking for based on the master bar code of the case. Alternatively, the physical or electronic location of a particular document in the case can be provided from a document bar code.

A client computer 16 may additionally require software for converting a bar code into a request for data from the server 12 for example. The bar code software resides on a second storage device 34.

The client computer 16 operates an Internet browser such as Microsoft Internet Explorer, Netscape Navigator, or other third-party web browsing software. The Internet browser software manages the data transferred via the communication network 18 from the web-based immigration software. The data may be in one of many forms including HTML code, XML code, and applets.

HTML, for example, is the page description language used to format pages for viewing on the World Wide Web. Formatting tags are embedded in a text file. These formatting tags are interpreted when the document is viewed in a web browser. These formatting tags may include applets, which are programs written in JAVA language, which can be distributed as an attachment in an HTML document. Once an applet is transferred to the client computer 16, it is executed by the client browser's JAVA decoding software, such as JAVA Virtual Machine.

The communication network 18, for example, the Internet, shown in FIGS. 1A & 1B, is preferably a wide area network (“WAN”), as opposed to a local area network (“LAN”). A WAN is a communication network that extends over a broad area, such as for example, interconnecting communication facilities in different parts of a country. A LAN is limited to a private internal communication network confined to a small area, such as a single building or a group of buildings in a single area. Therefore, a client computer 16 preferably connects to the server 12 globally via the Internet.

Once the hardware for the system is in place, the case management software is used between one or more client computers 16 and server 12 to manage data, complete forms and generate action notices to attorneys, among other things.

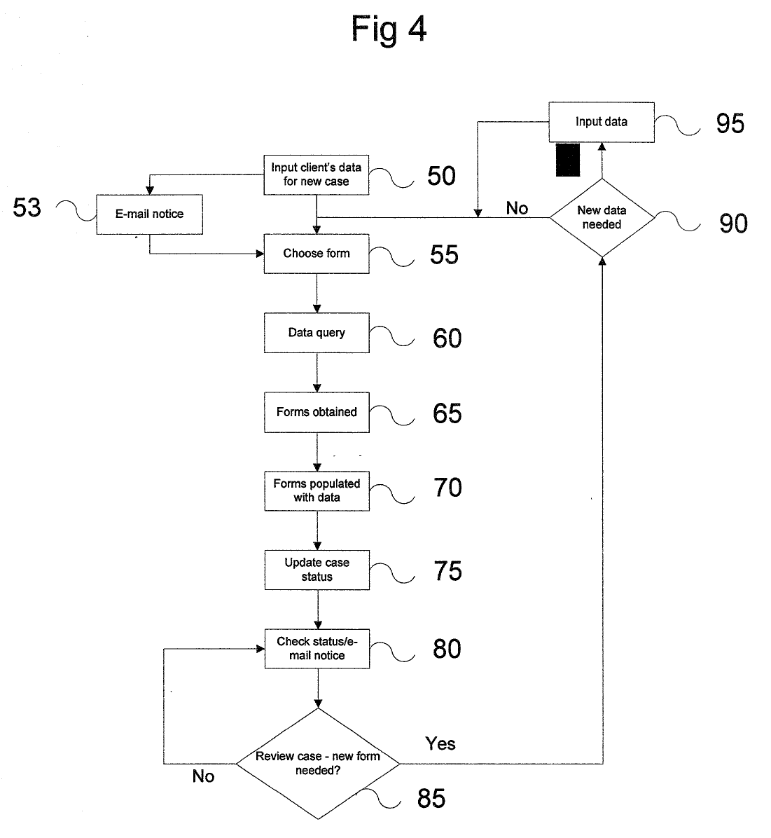

FIG. 4 is an overview of the case management method embodied by the software and provided by system 10. The method includes secured management of cases online, automated creation of cases, automated reporting to clients, attorneys, and paralegals, automated populating of INS forms, and tracking of cases.

As seen in FIG. 4, first a law client's data is entered 50 into database 14. The data is preferably entered by the law client connecting to the server 12 containing the software and database 14 via the communication network 18 with a client computer 16. Alternatively, an attorney or other law firm employee may enter 50 the client data during an interview with the law client. The information is stored in the database 14 and the case initialized, as described further below. The law client information may be input following the directions of a software wizard to prompt entry of information that will be needed for a variety of situations.

The software wizard may include a final step which launches a routine to generate and send a notice to the attorney via e-mail 53 that the new case has been created and requires attention. The routine can generate a stock message with basic information, such as the case docket information or other case identifier, the name of the assigned attorney and possibly an indication of the nature of the case, if that information was requested during the data entry.

Then, immediately or at a subsequent time, the attorney assigned to the case chooses the type of filings that are required for the particular law client's case. Based upon the type fo filing, the database 14 automatically selects the relevant forms 55 which must be prepared. The attorney may make these decisions online using the client computer 16 and server 12 hardware and software of the system 10.

Once the case type and forms are selected 55, a software routine is executed to automatically obtain the relevant data for each selected form from the database 14 via a data query 60. Preferably, the software for completing the selected forms executes on the server 12, so that the form filling is accomplished faster as a local operation at the server 12. However, it is possible for the client computer 16 used by the attorney to have the software routine on the client computer for executing the data query 60 across communications network 18.

The software routine then executes instructions for obtaining the preselected form 65 corresponding to the one the data was queried and obtained 60. The forms are preferably those provided by the Immigration and Naturalization Service (INS) for use by attorneys and their clients. In a preferred embodiment, a library of all forms needed to practice Immigration law are downloaded from the INS Internet web site computer and are stored in the second storage device 22 of server 12. The software routine can then retrieve the necessary form from the server 12 and open it for use.

Then, the retrieved and opened form is populated 70 with the data obtained from the database query. The forms include input fields that are populated with the data by the software routine. The form preferably includes a document number which is coded onto the document using bar codes for later identification by the system 10.

After the form is populated 70, the case status is updated 75 to reflect that the form was completed. Subsequent entries can be made using the system 10 to indicate when the form was filed with the INS or other government agency, when it was received, and if there are any action dates to set alerts.

In a preferred embodiment, the system 10 then regularly checks the status 80 of the case for alerts. If alerts are set, and the software detects that an alert date has arrived or is past, a notice is generated to the appropriate person and e-mailed to that person. The system 10 may also prompt the person who receives the notice at a preset amount of time prior to the set date in the alert. The person receiving the notice may be the attorney or a paralegal. The notice can be copied to the client to help alert them, for example, when a necessary court appearance is upcoming.

Upon receipt of a notice from the system 10, the attorney, paralegal or law client can all review the status of the case 85 and determine what steps they must take next. The case status can be reviewed by accessing the case file via the system 10 using remote access to the server 12. The law client's review of the case can be limited by system security procedures, so that forms cannot be altered or deleted, but important dates and the status of the case at the INS, if known, can be viewed.

The attorney or paralegal have greater access when they review the case 85. The attorney can determine if additional forms or filings are needed. If no forms are required, the case status and alerts are updated 75 and no further action is taken until the next e-mail notice is generated and delivered.

When a new form or filing is required, the attorney or paralegal reviewing the case can determine if new information is required 90 from the client or other sources. New data is input 95 by either the attorney or paralegal, or by having the client access the system and enter new data as required.

Once the new data is input 95, or if no new data is required, the process of selecting a case type and obtaining forms 55 and completing the form 60, 65, 70 is repeated, followed by updating the case 75, until the law client's case is closed.

The method and software illustrated by FIG. 4 is preferably implemented with computer routines programmed using Macromedia's COLD FUSION programming language. The COLD FUSION language is an Internet-compatible server programming language that can be used to create routines which will link user inputs to a database, such as database 14. The COLD FUSION programming permits querying the database 14 based on user input. The query may specify certain keywords, or a relationship between one matter and another. Additionally, pre-defined queries are programmed that map data fields from the database 14 to the appropriate forms. The COLD FUSION programming populates the form fields of a INS form with the data obtained from the query of the database 14.

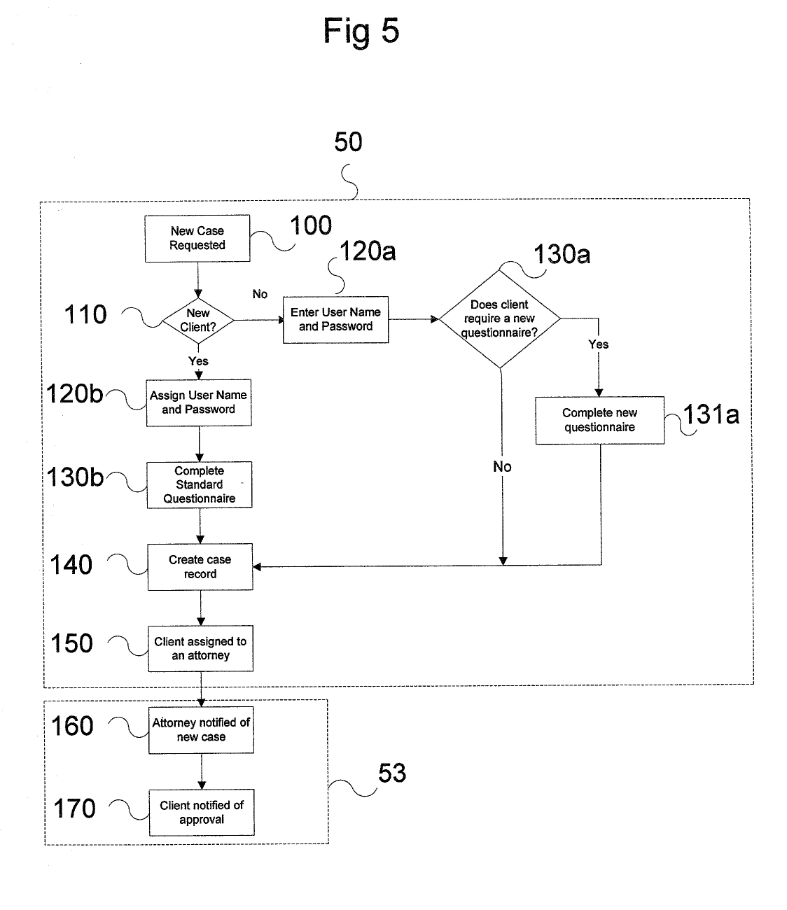

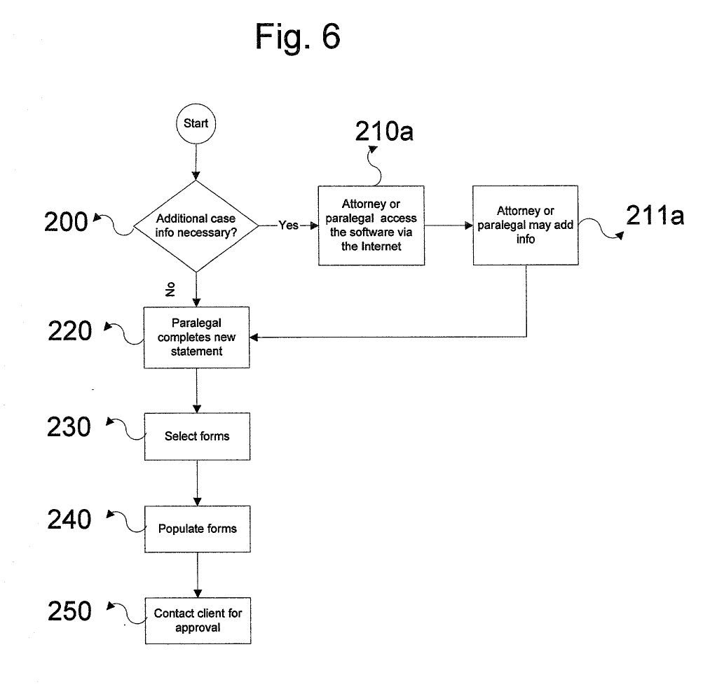

FIG. 5 displays elements of the system 10 in greater detail. FIG. 5 illustrates a process for entering client's data 50 and notification 53 when beginning a new case in more detail.

In FIG. 5, detail of the processes of initializing the case by entering client data 50 and notifying the assigned attorney 53 are shown. First, either the law client or personnel of an immigration law firm may initiate the case by requesting a new case 100. Initialization 50, 53 of the case is performed online using the system 10.

When the law client initializes the case 50, 53, she preferably connects her client computer 16 to the server 12 by pointing her web browser software to the a server homepage at a fixed internet address, such as a URL or IP address. The homepage is preferably created using Macromedia COLD FUSION programming. The homepage provides a starting point for initializing a new case by a law client or attorney, and includes a button or link for requesting a new case 100 to be started for the law client.

After requesting a new case 100, the law client is prompted 110 with a login screen or a separate option to register as a new client.

If the law client is a new client, they must register to obtain a user name and password. The client registration is preferably guided by a step-by-step registration wizard, so that a user name and password combination can be assigned 120b. As part of the registration process, the new client uses web browser form fields to enter their preferred user name and password. Assuming the combination is available, the user name and password are activated and the law client can subsequently log into the web-based software for the first time.

If the law client has previously retained the attorney or law firm, he may simply log in by choosing the log in option on the first page of the immigration law firm's web site and entering his user name and password 120a.

Alternatively, an attorney may initiate the case during an interview with the client. The attorney will either access the case management software by logging into the system with the client's user name and password 120a, or he may assign a user name and password 120b to the client.

Once a new client is logged in to the server 12, the software routines prompt the law client to complete a questionnaire 130b to obtain relevant data for the case. The questionnaire is preferably presented through an Internet web browser on the client computer 16, and can be presented in any compatible format, such as HTML.

To complete the questionnaire 130b, the new law client selects or enters information displayed in form fields. The form fields may consist of empty boxes for filling in alphanumeric text, drop down menus with selection options such as “yes” and “no,” or checkboxes. The client may input information into the form fields by typing with a keyboard or using another input device 38.

If the client is a new client, he will generally complete a standard questionnaire. The questionnaire can be interactive and structured to prompt for different information depending on the law client's answers to particular questions. In such manner, only data relevant to the current case will be collected. Alternatively, a broad range of information, including information that may not be needed for the current case, but may be needed for other immigration-related matters can be collected using the initial questionnaire. For example, information about whether the client has ever been convicted of misdemeanors or felonies might always be collected, but information about marital status or the citizenship of the client's spouse may not be collected initially in certain situations.

An existing client, however, may need to complete a new questionnaire to obtain additional information not already provided. The client is initially questioned about the type of matter and a determination is made 130b by checking existing client data whether a new questionnaire must be completed to obtain needed information for the new case.

If a new questionnaire is needed, the law client is prompted to complete a new questionnaire 131a to obtain the missing information. Alternatively, an attorney may complete the questionnaire for the client during an interview. In each case, in a preferred embodiment, basic client information that has previously been entered is automatically pre-entered into the questionnaire for acceptance or modification by the client or attorney.

Once the questionnaire has been completed, a new case record is created 140. The data from the questionnaire is stored in the server database 14 and indexed according to the relation to the client and case matter. A case record identifier is assigned. A bar code label can be generated and printed for affixing to paper files and physical paper forms based on the case record identifier.

The case record is then assigned to an attorney within a firm 150. When the client is an existing client, the same attorney who has handled prior cases for the client will be assigned. Each client is preferably assigned a primary attorney for contacting. The primary attorney may assign other attorneys tasks in connection with the client's case. For new law clients different methods of assigning attorneys can be used, or the assignment can even be based on selection by the client during completion of the questionnaire.

The system 10 then generates and sends notices to the attorney and/or client 53. The assigned attorney will automatically receive an e-mail notification of the new case 160. The assigned attorney can then access the case using the system 10 and review the case information for selecting forms 55 and taking other action.

In one embodiment, the system 10 has a holding queue, or temporary storage database, which can be accessed by the attorney after receiving e-mail notice and that allows the attorney to review the client information entered in the questionnaire in order to determine if the case can be accepted or if more information is needed from the client. If the case is determined to be acceptable for further work, the law client is sent an automatic notification 170 upon approval by the attorney. The approval notice to the client is also preferably sent via e-mail.

An attorney, paralegal, or other authorized personnel may access the software on the server 12 for starting, updating or checking a new case via the Internet 18. As previously mentioned, each attorney and paralegal has a user name and password that they may use to log into the system 10 software. Preferably, the attorney, paralegal, and other authorized law firm personnel are granted read and write access to all the databases and software. They may also access a particular case file via scanning of a bar code representing a case record identifier on a particular document that is part of the case. The Internet-based software embodying the case management features will automatically organize and display a specific client's pending cases only for an authorized user, such as the attorneys or the particular client.

When the system 10 is used to generate forms for use in a client's case, preferably all relevant related correspondence is also generated. That is, the system software generates and completes the forms that were preselected by the attorney, and any necessary statements or affidavits are then populated with data from the database 14, that was obtained from the client via the preliminary questionnaire. The system software also constructs cover letters to the INS and/or the client's employer or other persons, depending on the selected case type. In a most preferred embodiment, the system 10 can be used to send the entire case package, which includes all relevant INS forms, statements, affidavits, and cover letters, to the client via e-mail for approval. Alternatively, the client may be simply notified of the completion of the entire case package, and may be given specific instructions for viewing the case package online or requested to arrange a physical meeting with the attorney for approving and signing documents.

The generated forms are preferably compatible with electronic signature software applications, so that when permitted, the law client can electronically sign and approve all of the documents in the case package. Alternatively, the law client can approve the case package by printing, signing, and returning the documents to the firm via courier service, mail or fax.

While a specific embodiment of the invention has been shown and described in detail to illustrate the application of the principles of the invention, it will be understood that the invention may be embodied otherwise without departing from such principles.

What is claimed is:

1. A system for initializing and managing immigration law cases by attorneys and clients comprising;
server means for receiving and storing law client information and a plurality of forms, the server means comprising a relational database;
a communication network;
client computer means for attorneys and clients to enter and access the law client information on the server means via the communication network;
software means loaded on the server means for collecting the law client information, populating a selected one of the plurality of forms with the law client information and storing a case status; and
e-mail means for generating and transmitting e-mail messages across the communication network based on the case status.

2. A method for automated creation, processing and managing of an immigration law case using a computer network having a server, comprising:
connecting to the server using a remote computer;
entering a law client information into a database on the server using the remote computer to initialize a client case from the entered law client information;
notifying an attorney to review the entered law client information;
selecting at least one form from a library of forms;
querying the database to select a portion of the law client information corresponding to the selected at least one form;
automatically populating the selected at least one form with the selected portion of law client information to generate a completed form; and
updating a status of the client case.

3. A method according to claim 2, wherein entering the law client information is done by a client.

4. A method according to claim 3, wherein the law client information is entered using a questionnaire.

5. A method according to claim 3, further comprising setting alerts after updating the status, and subsequently generating and sending notices corresponding to the alerts to the attorney.

6. A method according to claim 2, wherein notifying the attorney comprises generating and sending an e-mail.

7. A method according to claim 2, wherein the querying is done automatically based on the at least one form selected.

8. A method according to claim 2, further comprising assigning a client case code to the client case.

9. A method according to claim 8, further comprising marking each completed form with a bar code corresponding to the client case code.

10. A method according to claim 9, further comprising scanning the bar code on the completed form to retrieve the client case on the server.

11. A method according to claim 2, further comprising checking the status of the client case, determining if additional forms are required for the client case and when additional forms are required, determining if new client information is needed to complete the additional forms, and repeating the querying, automatically populating and updating until additional forms are not required.

12. A method according to claim 11, further comprising notifying a law client of the status of the corresponding client case following updating the status.

13. A method according to claim 12, wherein the notifying the law client is done by generating and sending e-mails.

14. A method according to claim 2, further comprising notifying a law client of the status of the corresponding client case following updating the status.

15. A method according to claim 14, wherein the notifying the law client is done by generating and sending e-mails.
